(19) United States
(12) Patent Application Publication
(10) Pub. No.: US 2012/0091379 A1
(43) Pub. Date: Apr. 19, 2012

(54) Water Conservation Shower Valve

(76) Inventors: Ulric S. Todman, New York, NY (US); Michael Richard Weiser, New York, NY (US); Ulric A. Todman, (US)

(21) Appl. No.: 12/904,431

(22) Filed: Oct. 14, 2010

(51) Int. Cl. F16K 1/00

(52) U.S. Cl. 251/319

(57) ABSTRACT

A pushbutton device that will stop the flow of water to the showerhead by closing a valve after the hot and cold water is mixed to the desired temperature and water force. This button will operate a simple “push-to-open/push-to-close” valve, which will interrupt the water flow to the showerhead. The button will be clearly marked PAUSE, and will be visible to the user. While the button will highly visible to the user, it will be mounted in low relief to the wall, with smooth and rounded surface and edges, and will not pose a danger to the user in the event of a slip in the shower. This invention is meant to enable the user to instantly change the amount of water used for showering, by allowing the user to immediately stop the water flow and re-start the flow, without the need to re-adjust the water temperature and water force. Once the temperature is set and the water force is achieved the user will able to stop and start the water without having to reset. The objective is to enable the user to save significant amounts of both water and the energy needed to heat the water to the desired showering temperature, without having to spend any time, at all, thinking about it.

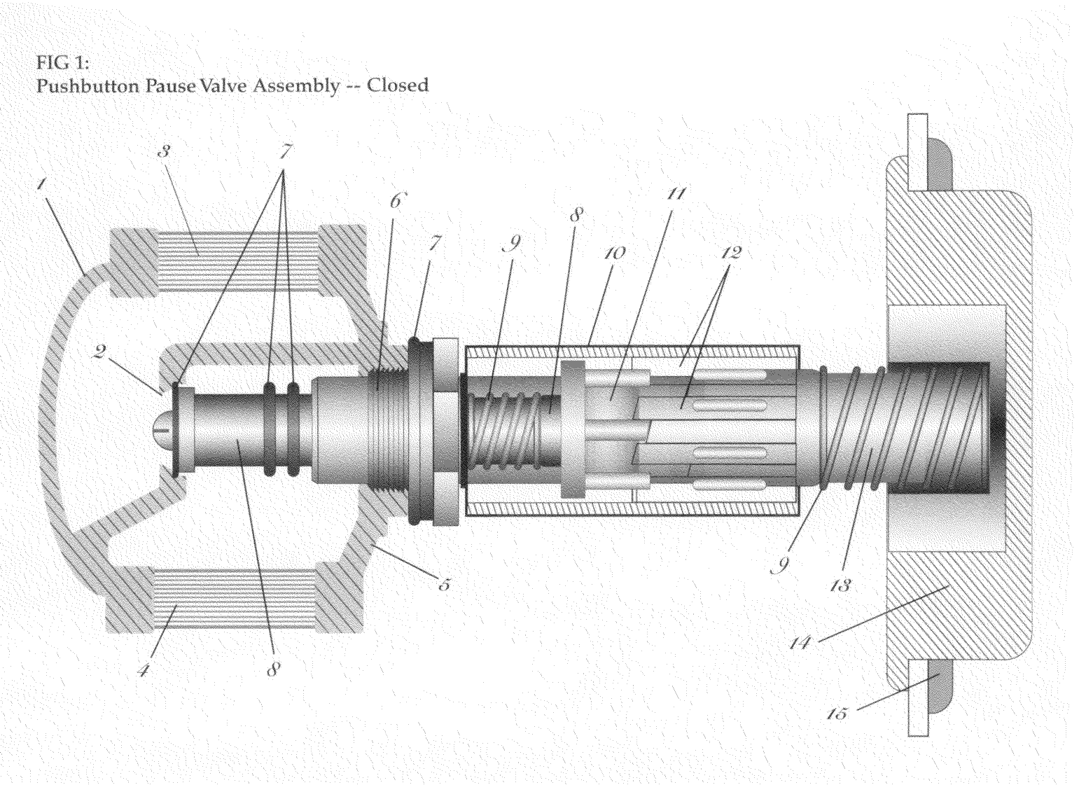

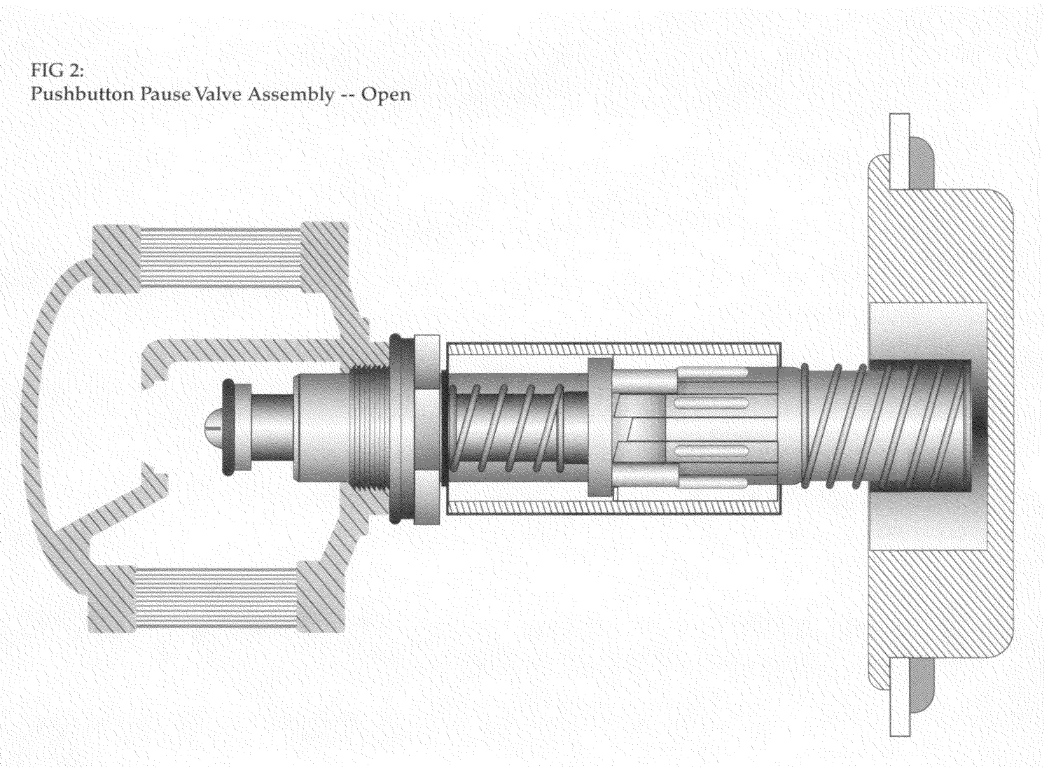

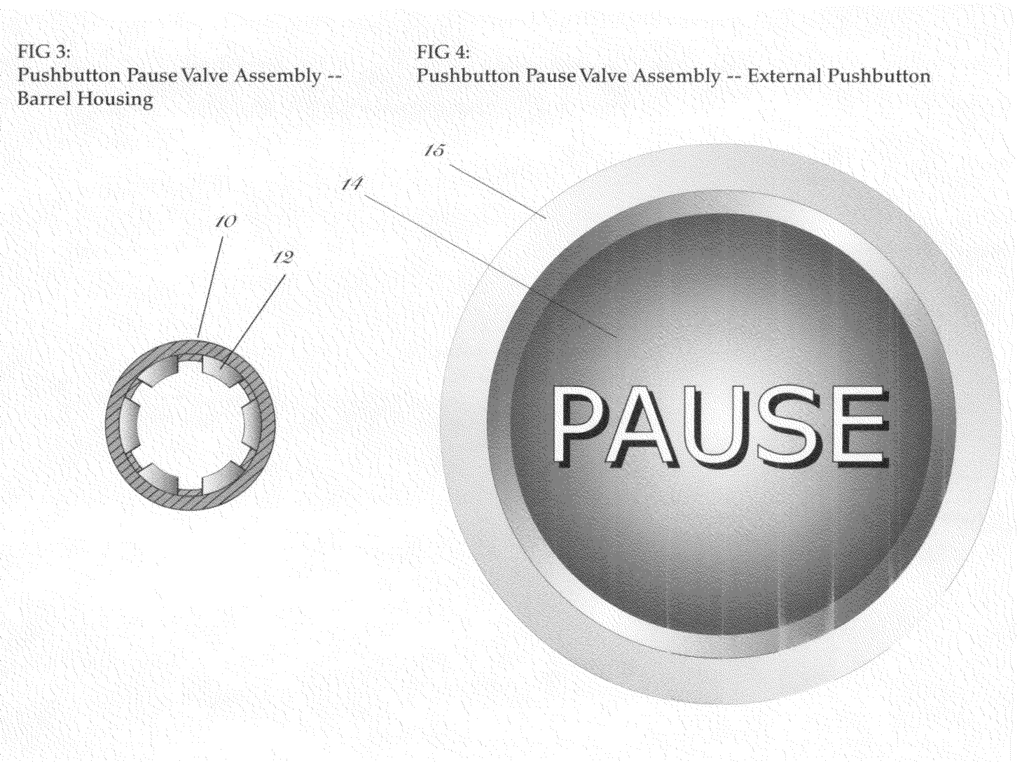

### FIELD OF INVENTION

An on/off water control device which opens and closes a valve that allows the user to stop and re-start the flow of pre-mixed water in the shower, through the simple pressing of a button, without the need to re-adjust the water mix temperature or flow force of the water.

In the United States, showering is an activity that consumes more water than virtually any other daily activity. A shower will consume as much as 2.5 gallons of water per minute. That adds up to 37.5 gallons for a 15-minute shower, or 50 gallons for a 20-minute shower. And, all the time the water is running a significant portion is wasted because most people won't turn off the water between lathering and rinsing. They don't want to have to re-set the temperature and flow force each time they turn the water off and on, so they would rather keep the water running for the entire duration of the shower. In addition, significant energy is expended in heating water to adequate temperatures for showering, so the amount of energy wasted in heating water that is ultimately wasted can add up rapidly.

This invention is concerned with the conservation of water, and with conservation of the energy needed to heat water as it relates to the taking of showers.

### DESCRIPTION OF PRIOR ARTS

These include, a shower valve cutoff device controlled by a manually operated soap dish lid (U.S. Pat. No. 4,508,141), which appears as if it would constitute a hazard to the user, because of the dish's significant protrusion into the shower area and evident sharp edges, that could cause serious injury to anyone that might slip in the tub. Also (U.S. Pat. No. 6,016,836), a programmable device, that automatically limits the time that unrestricted water is allowed to flow during a shower, and (U.S. Pat. No. 4,921,209), which also limits the time that the water is allowed to flow, then the user must wait a certain amount of time before the water is allowed to run again. Neither of these devices appears to be very practical (you can just imagine standing around covered with soap, waiting for the water to come back on).

### BACKGROUND OF THE INVENTION

This purpose of this invention is to enable the user to conserve water, during a shower, whenever it is not necessary for the water to be running (while lathering or shampooing, for example), without the need to completely turn the water off at the main controls, and without the need to re-set the water temperature and flow force each time it is desired to turn the water back on. As stated previously, the primary objective is to allow the user to be able to effectively conserve both water and the energy required to heat water to useful temperatures, without the user having to go out of their way or to inconvenience themselves to do so, and without having to spend a lot of time thinking about it.

Another objective of this invention is to improve the way water is cut off to the showerhead, by the use of both a simpler internal mechanical function, and by simplifying the action required by the user. This simpler action on the part of the user is achieved by means of a single “push-to-stop/push-to-start” button, mounted at chest height, and positioned in extremely shallow relief from the wall.

### BEST FEATURES OF THIS INVENTION

Simplicity. The mechanism operates with a simple in-and-out movement, activated by a conveniently located pushbutton. In addition, the device is simple to use. Push the button once and the water stops. Push the button again, and the water starts again—at the same temperature and force settings. Both water and energy savings can be achieved through the use of a simple and convenient device, almost without having to think about it. In addition, an indirect saving in soap will be experienced.

What is claimed is:

1. An operating mechanism for a simplified, pushbutton on/off valve control device for installation, along with a standard two-chamber valve, as part of a water delivery system in a shower, comprising:
a spring-loaded pushbutton firmly affixed to one end of a lower piston structure, the opposite end of which features raised, sawtooth ribs, which operatively engage with corresponding angled projections on an upper piston locking structure. Said upper piston locking structure moving freely into and out of the lower piston structure, and rotating as the angled projections of the upper piston locking structure engage with the sawtooth ribs on the lower structure, when the mechanism is activated by pushing the button; and
a valve stem and shaft permanently affixed at its base to one end of the upper piston locking structure, the other end of said valve stem shaft being formed, and bearing an installed washer, to effectively close the divider aperture valve seat located inside the two-chamber, valve when the lower piston and upper piston locking structure are activated by pushing the button, and
a cylindrical barrel housing which contains the mechanism components and features molded, angled flanges around the inside perimeter of the housing, said angled flanges engaging with the angled projections of the upper piston locking structure, in either the open and un-locked, or the closed and locked position, when the mechanism is activated by pushing the button.

2. The operating mechanisms of claim 1, wherein the sawtooth ribs on the lower piston structure are distributed evenly around the structure, and spaced precisely with respect to the angled projections on the upper piston locking structure, so that engagement of the lower piston structure with the upper piston locking structure causes the upper piston structure to rotate clockwise a predetermined distance, thereby allowing the angled projections to effectively engage with and lock into the angled flanges molded around the interior of the cylindrical barrel housing.

3. The operating mechanism of claim 1, wherein a valve stem is inserted through a threaded closure plug and affixed to a valve stem shaft, which is, in turn, affixed to the upper end of the upper piston locking structure.

4. The operating mechanism of claim 3, wherein a threaded closure plug is affixed to the upper end of a cylindrical barrel housing (in claim 1), the opposite end of which plug is threaded firmly into the corresponding threaded opening of a standard, two-chamber valve (in claim 1), allowing for forward and backward movement of the valve stem, thereby plugging the divider aperture valve seat, when the mechanism is activated by pushing the button.
